(19) United States
(12) Patent Application Publication
(10) Pub. No.: US 2006/0080155 A1
(43) Pub. Date: Apr. 13, 2006

(54) Method and apparatus for insuring multiple unit dwellings

(75) Inventors: Don Taylor, Salt Lake City, UT (US); Marcellus Barrus, Salt Lake City, UT (US)

Correspondence Address: MARCUS G THEODORE, PC, 466 SOUTH 500 EAST, SALT LAKE CITY, UT, 84102, US

(73) Assignee: Renters Legal Liability, LLC, a limited liability company of the State of Utah, Salt Lake City, UT (US)

(21) Appl. No.: 11/274,875

(22) Filed: Nov. 15, 2005

Related U.S. Application Data
(63) Continuation-in-part of application No. 11/134,643, filed on May 23, 2005.
Application No. 11/134,643 is a continuation-in-part of application No. 11/020,152, filed on Dec. 27, 2004.
Application No. 11/020,152 is a continuation-in-part of application No. 09/947,330, filed on Sep. 7, 2001.
Application No. 09/947,330 is a continuation-in-part of application No. 09/921,251, filed on Aug. 3, 2001, now abandoned.
Application No. 09/921,251 is a continuation-in-part of application No. 09/476,559, filed on Jan. 3, 2000, now abandoned.

(51) Int. Cl. G06Q 40/00

(52) U.S. Cl. 705/4

(57) ABSTRACT

A method and apparatus for insuring the owner of an apartment or multi-unit dwelling from damage to his building caused by his tenant's unintentional acts comprising: inputting into a computer processor a database of building physical information, occupancy information, and tenant rental information; inputting into the computer processor an insurance qualification program for renters legal liability insurance covering the building owner from unintentional damage caused by the tenant from fire, smoke, explosions, water damage, or negligence injuries by the tenant caused to third parties pursuant to predetermined insurability criteria; qualifying the building for renters legal liability insurance, and computer translating and generating insurance coverage for the building owner based on the number of units in the building and insurance coverage limits desired, and billing the owner for renter's legal liability insurance.

### RELATED APPLICATIONS

This application is a continuation-in-part of the continuation-in-part application of United States Letters Patent entitled METHOD AND APPARATUS FOR INSURING MULTIPLE UNIT DWELLINGS, filed May 5, 2005, Ser. No. 11/134,643 of the continuation-in-part of the continuation-in-part application of United States Letters Patent entitled METHOD AND APPARATUS FOR INSURING MULTIPLE UNIT DWELLINGS, filed Dec. 27, 2004, Ser. No. 11/020,152 of the continuation-in-part of the continuation-in-part application filed Jul. 7, 2001, Ser. No. 09/947,330 entitled “Method and Apparatus for Insuring Multiple Unit Dwellings” of the continuation-in-part application filed Aug. 3, 2001, Ser. No. 09/921,251 entitled “Method and Apparatus for Insuring Multiple Unit Dwellings” of the original application entitled “Method and Apparatus for Insuring Multiple Unit Dwellings”, Ser. No. 09/476,559 filed Jan. 3, 2000.

### BACKGROUND OF THE INVENTION

1. Field

This invention relates to methods for insuring owners of and tenants occupying multiple unit dwellings and buildings. More particularly, it relates to a method and apparatus to insure the owner and tenants within apartments or multi-unit dwellings from accidental losses caused by the tenant.

2. State of the Art

Joint insurance coverage for owners of and tenants occupying multiple dwelling units in a building is currently not possible to write, because it is cost prohibitive to issue a large number of small policies covering individual units. Further, many lease clauses require renter's insurance coverage. However, approximately 90% of the 35 million apartment units in the United States are currently uninsured. Landlords currently do not have a process to verify or enforce the lease requirements of mandatory insurance. This places an enormous burden on the insurance agent to try and maintain adequate insurance coverage for the building owner. There is currently no insurance liability trail back to the tenant. Nor is there a product or method currently available to mass insure all tenants of an apartment building or multiple unit dwelling complexes. Renters insurance, unlike homeowners insurance, which normally has a third party, the mortgagee, as the enforcer, has currently no means of enforcement. This being the case, present insurance methods do not allow insurance companies to apply the principles of large numbers. The principle of large number provides for the spread of risk over members of a similar pool, allowing insurance companies to actuarially lower costs, increase profits and improve service.

The patent references of record fail to suggest insurance coverage to protect both the landlord and tenant from negligent acts by the tenant that affect the building owner from unintentional tenant acts causing fire, smoke, explosion and water damage to the building units, whether occupied or not. Luchs et al, U.S. Pat. No. 4,831,526 issued in 1989 discloses a computerized insurance premium quote request and policy issuance system primarily for use in the automotive, watercraft, dwelling, and personal liability insurance area. The method disclosed provides for preparing and writing insurance contracts via computer terminals and correction displays before printing out the policy. It does not address providing limited streamlined multi-unit coverage to provide reduced group rate insurance to building owners.

Dillard, U.S. Pat. No. 6,236,973B1 issued May 22, 2001 is an apparatus and method for providing collateral construction loan insurance coverage. It addresses a centralized automated apparatus for lending institutions to track insurance coverage on buildings used as collateral for construction loans under a single builder's risk policy. This apparatus provides management reports for the lending institution, and tracks premium payments and repayments for closed loans, and loss evaluations. Again, this reference does not address providing limited streamlined multi-unit group multi-unit coverage to provide reduced group rate insurance to building owners.

Brown et al., U.S. Pat. No. 5,978,769 issued Nov. 2, 1999 is a system and method for determining and analyzing building occupancy using geographically based structures to identify potential clients, perform carrier exposure aggregation and associated with operations performed by other occupants. This reference does not address issuing limited streamlined multi-group multi-unit coverage for the building owner, but is used as an actuarial risk-assessment rating tool.

Other business method patents address using computers to gather information from building sales and complexes to generate reports, which value and manage business complexes based on information concerning each unit in the building. Weatherly et al, U.S. Pat. No. 6,023,687 issued Feb. 8, 2000, utilizes a computerized system and method for creating and managing lease agreements. This patent tracks lease payments, issues lease policies, and provides periodic reports. It also incorporates telecommunication links between lessor computers and the lease control computer.

The Joao (U.S. Pat. No. 6,347,302) Labadorf et al. (Lead Paint Removal: What Insurers Won't Tell You!) and Merritt Editors (How to Insure Your Home) references previously cited by the Examiner in the parent application to preliminarily reject applicant's insurance method discuss insured occupied homeowners and lessee's premises insurance providing coverage for protecting individuals and/or business entities from liability which may arise as the result of excess wear and tear and/or damage which may occur to a leased and/or rented entity during the lease and/or rental term, and further for protecting individuals and/or business entities from liability for post-warranty repairs. The Joao, Labadorf and Merritt insurance products and method rely on an actuarial risk evaluation of dwelling units occupied by the owner or lessee of the unit. The insured was limited to those who actually occupied premises. Previously, it was believed that insured occupied dwelling units were subject to more control and monitoring to minimize risk and losses to the real estate.

Damage exposure for the owner who did not occupy units was thus not included in these homeowner insurance products. Nor was the owner of a multi-unit building covered for the actions of a tenant in his building.

Joao, provides an apparatus and a method . . . for providing insurance products, services and/or coverage which provides insurance coverage for protecting individuals and/or business entities from liability which may arise as the result of excess wear and tear and/or damage which may occur to a leased and/or rented entity during the lease and/or rental term, and further for protecting individuals and/or business entities from liability for post-warranty repairs, Col. 2, lines 8-17. As such, it is a named peril type of insurance coverage limited in scope to those perils described (excess wear and tear and/or damage which may occur during the lease and/or rental term). Joao does not teach a method wherein the type of insurance generated includes coverage to protect the multi-unit dwelling building owner from unintentional damage caused by his tenants from fire, smoke, explosions or water damage, or from negligence injuries caused to third parties, page 13 last paragraph Office Action mailed Mar. 24, 2004 in the parent application Ser. No. 09/921,251. Nor do Labadorf et al. teach this deficiency. Labadorf et al. discusses submittal of claims for lead contamination under all risk types of home owner's insurance policies, see page 2, numbered paragraph 16 discussing the 1973 comprehensive general liability policy.

Nor does the “How to Insure Your Home”, Merritt Publishing, Santa Monica, Calif. publication (Merritt) supply these deficiencies. Merritt discusses standard homeowner's insurance policies for condominium owners. Standard homeowner's insurance provides insurance coverage to the owner occupant of the property in accordance with the terms of the insuring agreement. The Merritt publication thus addresses a particular type of owner occupied insurance, which is not similar to applicant's insurance coverage for the building owner of multi-unit dwellings, such as apartment houses, where the owner most likely will not occupy the premises.

Cited for general interest are: Weatherly et al, U.S. Pat. No. 6,049,784 issued Apr. 11, 2000 and U.S. Pat. No. 6,023,687 issued Feb. 8, 2000 provide predetermined financial information regarding a potential tenant and a potential landlord to a lease control intermediary, and uses computers to evaluate the information to determine the acceptability of the financial risk associated with the potential tenant. It creates a service product in the form of a rent guaranty of periodic lease payments from the lease control intermediary to the landlord. A computer is incorporated into the method for creating and managing the lease agreement, if review of the tenant data falls within acceptable pre-programmed risk levels.

Hough, U.S. Pat. No. 5,414,621 issued May 9, 1995 provides a system and method for computing a comparative value of real estate based on assessment percentages and sales data of comparable properties using a computer and a multiple listing computer database. Information from various building sales is then used to determine “assessed value” and “phase value” based on price/tax factors.

Apgar, IV, U.S. Pat. No. 5,680,305 issued Oct. 21, 1997 provides another system and method for evaluating real estate based on amount, price, area, grade, and risk to provide a scoring rating system to provide a well-rounded picture of a particular real estate situation.

Rothstein, U.S. Pat. No. 6,058,369 issued May 2, 2000 disclosed a method and apparatus for monitoring the strength of a real estate market to make lending and title insurance decisions based upon a derived market index.

The method and apparatus described below provides insurance coverage to protect both the landlord and tenant from negligent unintentional tenant acts causing fire, smoke, explosion and water damage to the building units.

### SUMMARY OF THE INVENTION

The invention comprises a method and apparatus to gather, prepare, and maintain sufficient tenant insurance data to enable insurance coverage to be written to cover both the tenant and the building owner from unintentional tenant acts causing fire, smoke, explosion, and water damage. Renter's single interest (RSI) is now known as renters legal liability (RLL) coverage to avoid use of the term “single interest”, which is used in the insurance industry on conditional sales floaters to insure only the seller's interest in goods. RLL is provided by applicant under the service mark “Renters Legal Liability™”, and covers the building owner from unintentional damage caused by the tenant from fire, explosion, including the explosion of gases or fuel within the furnace of any fired vessel or within the flues or passages through which the gases of combustion pass, not including loss or damage by rupture, bursting or operation of pressure relief devices; or rupture or bursting due to expansion or swelling of the contents of any building structure, caused by or resulting from water, smoke causing sudden and accidental loss or damage not including smoke from agricultural smudging or industrial operations, and water that backs up or overflows from a sewer, drain or sump, and water or other liquids that leak, flow or overflows from plumbing heating air conditioning, or other equipment fixtures, pursuant to predetermined insurability criteria. It may also cover negligence injuries caused by the tenant to third parties pursuant to predetermined insurability criteria.

Prior to applicant's insurance method, no insurance product provided insurance covering multi-unit dwelling building owners from unintentional damage caused by tenants from fire, smoke, explosions, and water damage, or negligence injuries by the tenant caused to third parties pursuant to predetermined insurability criteria. The policy is presently in existence and is therefore actually reduced to practice.—None of the references cited above present evidence of similar insurance coverage. More importantly, no previous policies similar to the present invention were reduced to practice to anticipate or suggest the invention and insurance method. As a new insurance product and method, there is no previous evidence of prior combinations of references reduced to practice covering similar perils and insurance contract provisions to anticipate or suggest the invention.

Based on the RLL building coverage, the tenant may apply for tenant occupancy insurance (TOI). This coverage would be similar to a present renters policy. Coverage could include tenant property, liability to a third party and damage to the apartment building pursuant to predetermined insurability criteria. As TOI insurance is an add-on to the RLL building, it may be written at a group rate, thereby allowing the tenant a more affordable rate than heretofore available. The reason is because TOI insurance pricing is based on larger numbers of the entire building complex rather than the traditional underwriting for only one specific unit. This results in a larger insurance coverage pool lowering costs to issue, administer and cover any losses incurred in the building complex. The exact premium for TOI insurance coverage is also dependent upon the limits of coverage for personal property specified by the tenant. By limiting the extent of coverage, TOI insurance pricing is not open ended; thereby further reducing the premium charged. In addition, the premium rates for RLL coverage on the building owner may be reduced, depending upon the percentage of units in the building, which are additionally covered by TOI insurance. The method therefore takes advantage of the law of large numbers providing universal, capped, add on insurance coverage to the occupants of entire building at a very low cost.

The first step of the method is to input into a large computer database sufficient insurance information concerning each apartment or multi-unit dwelling complex within a geographical area.

### Databases

The databases inputted into the computer processor are:
a. “Building Physical Information” about the apartment complex or multi-unit dwelling complex from all owners and business managers seeking insurance coverage within a geographical area. This information is reviewed and updated monthly, and contains the full name of the insured, the mailing addresses of the units, and number of buildings. Additional information can be inputted such as the fire insurance policy on the building and building rating by the four basic types of construction recognized in fire insurance coverage—i.e. a Class A building is one with walls, floors, and roof of masonry or concrete, and with all load walls supported by an independent steel frame. A Class B structure is similar to Class A except that interior walls and floors are not constructed of masonry or concrete. A Class C building does not meet all specific requirements of Class B. A Class D building generally refers to frame structures and includes most private residences.
b. “Occupancy Information” about the apartment complex or multi-unit dwelling complex from all owners and business managers seeking insurance coverage within a geographical area specifying the total number of units occupied, and the total number of units vacant at the last reporting period.
c. “Tenant Rental Information” from all owners and business managers and tenants within a geographical area seeking insurance coverage containing the lease agreement requirements, a credit report on the tenant coded to meet legal confidentiality requirements, a criminal background check of the tenant, and a character reference check of the tenant to verify his past tenant conduct.

The above data is preferably received on-line via the internet, or in a variety of media types, including tapes, cartridges, discs, etc. and is integrated with a data integration system to include all relevant data, even though this initially generates redundant entries. Once the building physical information, the occupancy information and the tenant rental information data is entered, it generally doesn't change unless the building is remodeled or the building is damaged.

The other information varies continuously, and has to be periodically updated and inputted to reflect the current rental status and renter identity of each unit. The renter's legal liability coverage (RLL) begins on the date of occupancy and after data has been entered into the computer, and ends as of the date the tenant leaves and is removed from the system. Continuous monitoring insures that empty units are not covered, and that the current tenant is covered as an additional insured. This lowers the overall cost of insurance to the owner by avoiding payment for non-existent insurance coverage on empty units. For example, monthly entries are inputted by each property manager or building owner via an internet screen gathering the necessary information for transmittal through the internet. This information is thus preferably reported on standardized combined or separate interactive computer screens. The first standardized screen, or drop down sub-screen, is the Renters Legal Liability Insurance Management Screen, which will list all of the tenants in the apartment complex. Within this list, the property manager or building owner can view basic unit information as to whether the unit is occupied or vacant, who occupies the unit, when the lease expires, and a summary of insurance coverage. The summary of insurance coverage specifies whether the tenant is RLL Insured or if the renter has an HO-4 policy, and its expiration date. This computer screen is interactive, giving the property manager or building owner the ability to add, edit or delete any of the information pertaining to each unit during the month or reporting period.

Thus, an entry is made for every tenant in the apartment by unit, even though a tenant may occupy several different units. This may result in multiple entries for each tenant, but insures that there is at least one entry per occupied unit. Because the raw data is inputted in a variety of formats and error checking is done when data is inputted, there is no need for extensive personnel training time as to the proper data field inputs and procedures. The system can, therefore, be operated by property leasing personnel utilizing computers connected to the internet to update the system. The employment of property leasing personnel as an arm of the insurance sales force provides participation by persons more sensitive to the needs of their residents, communities, and homes. Thus, insensitive technically correct insurance sales jargon employing such as the terms “renter”, “tenant”, “apartment”, “tenement”, and “complex” is avoided in favor of managers protecting residents' homes. The property leasing personnel are also more familiar with the needs and vocabulary of the multi-unit housing industry, and therefore provide more meaningful and effective RLL and TOI product sales.

RLL, unlike other off the shelf products, is specifically designed to cover the multi-unit property owner from tenant liability as a single interest product. Off the shelf products do not allow this provision for the reason that the tenant is the named insured instead of an added insured. As previously stated, as named insured, the building owner is only protecting its interests and as such does not need to be a licensed insurance agent. Contractually tenant agrees to allow landlord to add their unit to the landlord's master policy.

The tenant's rent payment includes the renter's legal liability insurance coverage acquired by the landlord as named insured. The computer automatically adds to the monthly rent bills a surcharge for the added insurance coverage. Thus, the computer program prepares bills via a data sort from the compiled screens. Funds due can then be transferred on line via electronic funds transfers (EFT), Credit Cards, etc.

Other tenants may elect to provide a certificate of their own standard renter's insurance, which also covers their personal property in addition to damage to the unit. A traditional insurance certificate, which names the property owner as an additional insured and/or certificate holder of record is employed for this purpose. This information is then entered into the computer database to enable a building manager or owner to monitor the insurance status of the unit. Alternatively, tracking self certifying residents can be done by a remote central monitoring group interconnected to access of the system to alleviate the burden on the property owner. The insurance product thus has an endorsement naming the landlord as a certificate holder of record on any policy certificate. This means that in case the policy is cancelled by a tenant, the landlord will have 10 days pre-notification. The building owner would then electronically arrange for RLL coverage and the tenant billed via the system to insure 100% lease compliance. It is contemplated that insurance company credits to the policies covering the property owner's package insurance policy will be available where there is 100% lease compliance. 100% compliance may also make the property owner eligible for a preferred tier rating by participating companies. These participating companies offering credits for 100% lease compliance will be issued RLL certificates. RLL certified companies can advertise on-line on interactive web sites connected to the system where residents can purchase self generated TOI policies. Optional HO-4 form policies may also be offered on-line to residents as property liability for qualifying multi-unit complexes has already been purchased by the property owner in the form of RLL. Insurance companies offering traditional HO-4 form policies may also be linked to advertise on the website of participating companies under mutually agreeable terms.

Those ordering the HO-4 policies on-line under the present system may also be able to pay for this insurance as part of the lease payment. The system also enables property owners to charge a billing fee covering administrative expenses in addition to the premium for RLL coverage to provide an additional source of revenue for the building owner.

Tenants wishing to purchase their own tenant occupancy insurance based on the renter's legal liability insurance policy can also do so via the internet, once the building has been qualified for renter's legal liability insurance coverage.

The apparatus employs a computer processor to cross-index and sort the databases to insure that all tenants, owners, and insurance coverages are properly matched. In addition, the database inputs go through a testing process to check for errors and variances from previously submitted data. The identity of incomplete data is then summarized into missing information reports, which are sent to the submitting owner or business manager. These incomplete information reports may also be sent to the agent for the insurance carrier covering the apartment or multi-unit dwelling complex advising the insurance of the incomplete data forms and requesting the missing information.

### Methodology

The second step of the method is comprised of first compiling, inputting and expanding the database of tenant insurance information into a computer processor. A matching program is then inputted into the computer processor to repeatedly sort by building address a working database of the insurance status of each tenant. To insure the accuracy of the database, a statistical sampling and verification of the data provided is periodically performed.

The computer processor then generates a real time series of reports to the building owner, business manager, and various insurance carriers listing all of the insured and uninsured tenants of an apartment complex or multi-unit dwelling. Expired tenant insurance lists including but limited to self-purchased TOI and traditional HO-4 insurance may also be sent to these parties.

The insurance carrier generally pre-qualifies the apartment complex or multi-unit dwelling for renter's legal liability insurance, or tenant occupancy insurance via an actuarial assessment computer program inputted into the computer processor that establish the premiums required for each building. This qualification is generally conditioned on periodic updates of the database being provided by the building owner or manager that the occupancy and types of tenants do not materially fall to unacceptable levels. Once the building is pre-qualified, tenant risk will be insured against by renter's legal liability insurance when the tenant rents an apartment or dwelling unit. This renter's legal liability insurance will provide coverage to protect the landlord from unintentional acts of his tenants. RLL coverage is limited to the perils of fire, smoke, explosion and water damage, as well as liability incurred by the tenant so that the coverage can be automatically pre-approved and extended without any independent review triggered by additional risk factors involved in coverages, such as bodily injury. Typically, RLL insurance is capped at the value of the apartment unit, or a pre-set limit. For example, replacement cost as opposed to Actual Cash Value representing the depreciated value of the building in the event of loss could be specified to cover the real property to avoid a financial burden on the building owner in the event of loss. Actual cash value cost would still be specified for the tenants' personal property to eliminate any financial incentives for the tenants to start a fire to replace worn out personal property.

RLL insurance can be purchased incrementally to only cover units occupied by tenants or on a blanket policy basis covering all of the units in a multi-unit apartment or dwelling. The incremental purchase method progressively covers the entire complex as the units become fully occupied to become a blanket policy. In addition, the insurance actuarial rates per unit may include additional management and commission fees for administering the RLL insurance policy as a cost in the fees charged the owner and tenants for RLL insurance coverage.

RLL insurance also includes the good neighbor coverage, which provides a pre-set limit, such as a $1,000.00, for displacement costs for any non-negligent effected tenant and the negligent tenant.

Alternatively, the tenant may elect to participate in tenant occupancy insurance provided through the building owner. This allows the tenant to purchase insurance through a rent surcharge to cover tenant liability and personal property. The amounts of coverage for the building units are pre-approved by the insurance carrier and listed on internet screens. The tenant then simply checks the coverage desired, and the bill is added to the monthly rent charge.

Premiums are then periodically generated and billed to the building owner and tenant based on tenant occupancy and preferences at the end of each payment period. This allows the building owner the option to pay for insurance as the leases are renewed, rather than paid in advance. The method does not contemplate any earned premium at the inception for the reason that RLL insurance is mandatory and not optional unless the resident can prove similar insurance coverage is already in place. Based on the computer generated apartment complex or multi-unit dwelling occupancy insurance reports and updates, the building owner or manager can minimize the exposure from accidental tenant damage and provide another source of recovery in the event of loss.

### Apparatus

To perform the method, the apparatus comprises a computer processor associated with a memory storage system. Inputted into the memory storage system are building physical information, tenant occupancy information, tenant rental information, and a heuristic computer matching program. Before sorting, the computer then expands the database by common categories to provide corresponding insurance data for every tenant occupying a building or apartment. After qualification, an interactive printer or display monitor controlled by the computer processor then prints or displays the identity of qualified multi-unit dwellings or apartments, and the insurance rates and coverage available for renter's legal liability or tenant occupancy insurance. Information as to additional riders for additional insurance coverage may also be included. These interactive insurance screens may also include insurance questionnaires making inquiry as to a tenant's other insurance needs, such as automobile insurance.

The building physical information, tenant occupancy information, and tenant rental information database is preferably entered into the computer on-line via internet screens, but discs, magnetic tape strips, etc may also be employed. After the generation of the tenant database, random sampling and follow-ups may be conducted by the insurance carrier or building owner or manager to verify the accuracy of the database. If significant errors are detected, appropriate adjustments to the data entry gathering and procedures are made, or the insurance cancelled. Thus the method provides a novel tenant insurance coverage for both the tenant and owner in a pre-qualified geographical region.

The above method and apparatus thus provides a simple means for meeting the needs of both the tenant and building owner with insurance unique as to the time coverage begins and ends. It also generates insurance leads as to additional insurance through non-insurance personnel who are not paid a commission or salary. More importantly, it makes available a new insurance product covering both the landlord and tenant based on continual computer monitoring of the tenant insurance status of a multi-unit dwelling complex. It is not an off the shelf product requiring a comprehensive insurance sales license for sales and distributions. Instead, it is a limited coverage product pre-approved by state licensing authorities, which covers the building owner and tenant as an additional insured, and, if needed, can be sold under a limited insurance sales license.

The method and apparatus also provides a social benefit to the community in that an insurance remedy is offered instead of having to rely on community charitable resources, such as the Red Cross, when a large apartment fire occurs, keeping in mind that approximately 90% of the renter's in the United States are currently uninsured.

### DESCRIPTION OF THE DRAWINGS

FIG. 1 illustrates a schematic flow diagram of a preferred method and apparatus.

FIG. 2 illustrates a sample Renter's Legal Liability and Tenant Occupancy Computer Screen.

FIG. 3 illustrates schematic flow diagram of a preferred configuration of the apparatus.

FIG. 4 illustrates an example of a router connection to a global information/or network.

FIGS. 5 through 9 illustrate a series of flow sheets of a preferred method for purchasing and issuing RLL and TOI insurance when using a global information network.

FIG. 10 illustrates a preferred log in computer screen.

FIG. 11 illustrates a preferred Administration Area computer screen.

FIG. 12 illustrates a preferred User List computer screen.

FIG. 13 illustrates a preferred Add User Administration computer screen.

FIG. 14 illustrates a preferred Apartment List computer screen.

### DESCRIPTION OF THE ILLUSTRATED EMBODIMENTS

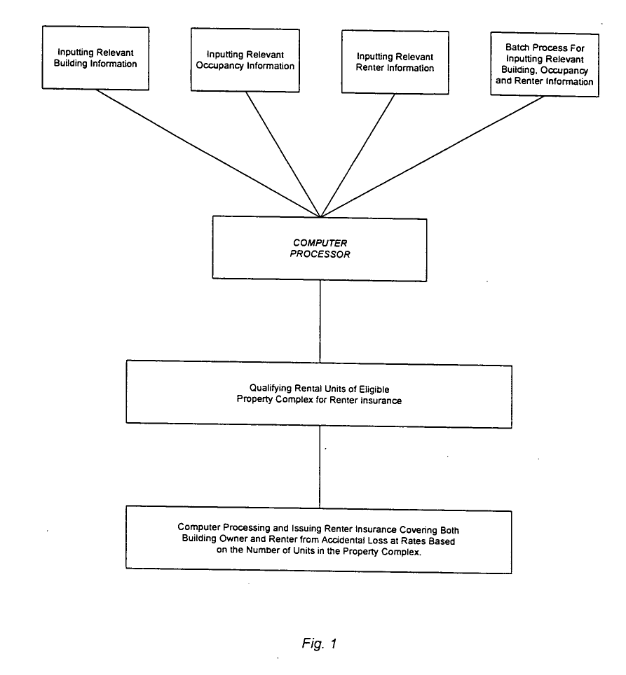

FIG. 1 illustrates a schematic flow diagram of the basic preferred overall method. The first phase of the method comprises first inputting into a computer database relevant building physical information, occupancy information, and tenant rental information. This information is then expanded and tested by the computer employing a matching program to insure that there is one record per unit. Thus every unit is matched with a tenant, and any renter's insurance policy. Reports of incomplete data are then sent to the building owner or manager, or insurance carrier to update and correct their files. An insurance qualification procedure is executed to qualify the property for tenant insurance, and establish the periodic premiums for payment by the tenant. In some cases, a property may be qualified by default without going through the qualification process procedures.

From the uninsured tenant lists, the building owner or manager can take appropriate steps to enforce the lease provisions requiring tenant insurance coverage. In addition, the working database can be monthly audited and statistically sampled to insure its reliability. Generally, this process produces monthly internal audit reports and provides additional insurance leads to those tenants desiring additional insurance.

The second phase of the method allows the uninsured tenants to purchase directly on-line tenant occupancy insurance. The database is then updated and a bill prepared based on the total number of units in the building qualified for insurance and sent by the computer to the landlord for inclusion in the monthly rent charges for the insurance additional coverage.

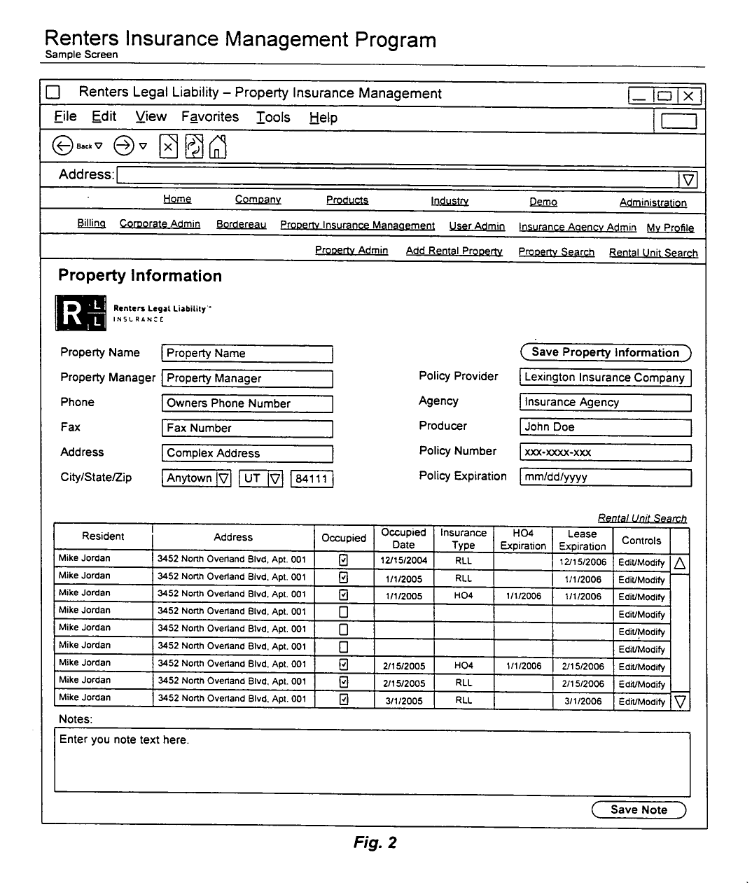

FIG. 2 illustrates an example of a combination Renter's Legal Liability and Tenant Occupancy Insurance Screen to computer gather information for issuing insurance. The Screen has draw down interactive sub-screens for listing all of the tenants in the apartment complex, the tenants that have purchased insurance through the apartment complex over the basic renter's legal liability coverage, the tenants that have provided their own insurance through other means, and those units not currently occupied. Generally, these interactive screens gather the relevant building physical information, such as the full name of the insured, the mailing addresses of the building units, the number of buildings, the fire insurance policy on the building and rating by the four basic types of construction recognized in fire insurance coverage. They may also gather the date the building was constructed, the protection class, number of fire hydrants, prior loss information as to liability and property claims, and any updating of the buildings, such as the installation of circuit breakers, wiring, roof replacement, plumbing up-grades, and heating and air conditioning replacement. In addition, the number of buildings in the complex, the units per building, and the units currently occupied in each building, may be in-putted.

The relevant occupancy information generally includes the total number of units occupied, and the total number of units vacant at the last reporting period. It may also include the building tenant's age, date of birth, marital status, type and length of employment, credit and criminal background checks, previous residence location, and prior losses. This information is then electronically transmitted to a large insurance database on a global information network.

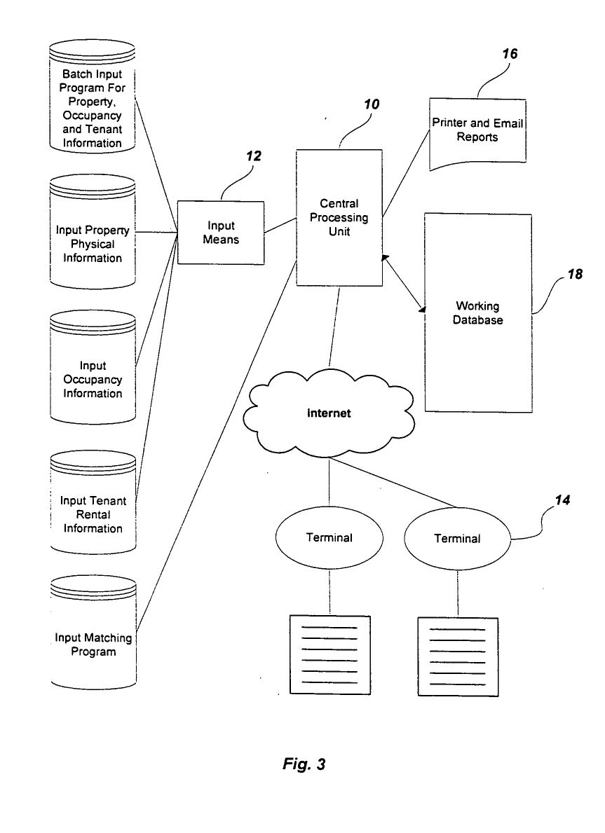

FIG. 3 illustrates schematic flow diagram of a simple configuration of the Renters Legal Liability (RLL) apparatus used to compute, translate and generate the working database for use and review by the building owner or manager. A computer processor, such as a personal computer 10, is operationally associated and connected to input means 12, such as a disc reader or keyboard (not shown), a display terminal 14, and a printer 16. The system is connected to the RLL apparatus through the global information network with the use of an Internet browser, the building owner or manager can interact with various databases including building physical information, occupancy information, and tenant rental information, and a sorting and matching program, which matches, and periodically tests the data before generating the tenant database.

The personal computer 10 then activates the computer terminal display 14 to display the insurance status for a given tenant for review. The personal computer 10 may then activate a printer 16 to print a list of uninsured tenants, or causes the information to be electronically transmitted to a building owner or manager. Any updates that are made on the personal computer 10 also are transmitted it to a database server 18, such as that described below through the global information network.

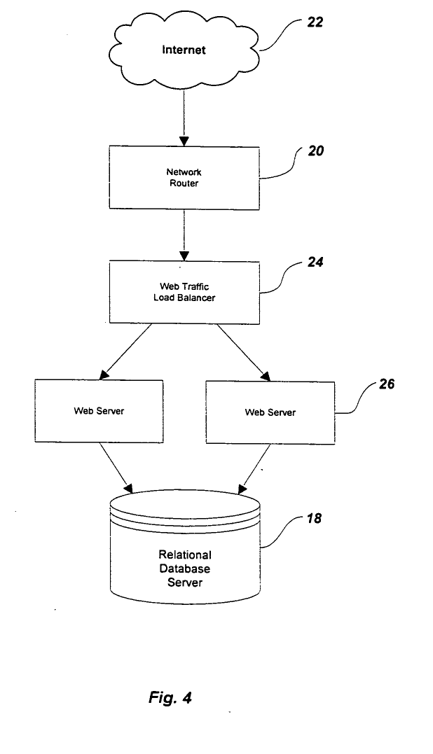

FIG. 4 illustrates an example of a router 20 and connections to the global information network (internet) 22 provided by the hosting facility to provide insurance on-line. A device such as the Alteon Switch 24 is used to do Smart Load Balancing to give support for web site load balancing as well as redundancy control. The Alteon Switch 24 is thus associated with two or more internet web servers such as a Hewlett Packard (HP) model LPR 2000 web server 26 which run a web server application such as the Apache Web Server or Microsoft's Internet Information Server with programming languages used to interpret process flow and business logic. Languages similar to PHP, ASP, Java, JSP and ASP.Net can be used in conjunction with the web server running on top of an operating system such as the Linux, HP-US, IBM AIX and Microsoft Windows operating systems. Each LPR 2000 web server 26 will have an internal and external NIC card (not shown). The external NIC cards will access the global information network 22, and the internal NIC cards will access the database of a database server 18. This structure gives added security to only allow web servers access to the database. No external devices will therefore be able to access the database. The database server 18 will be running the database server application such as PostgreSQL, MySql, Microsoft SQL Server, Oracle or Informix as the database on top of the operating system.

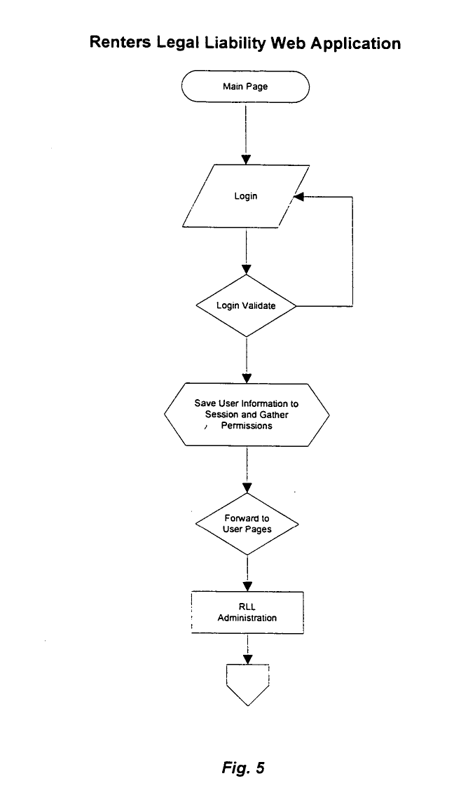

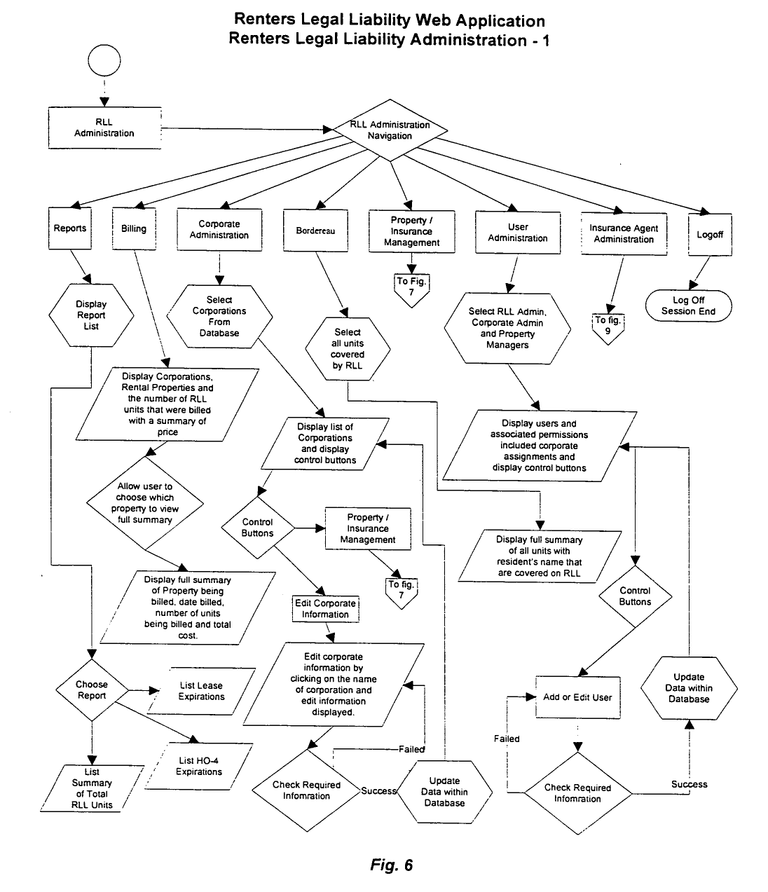

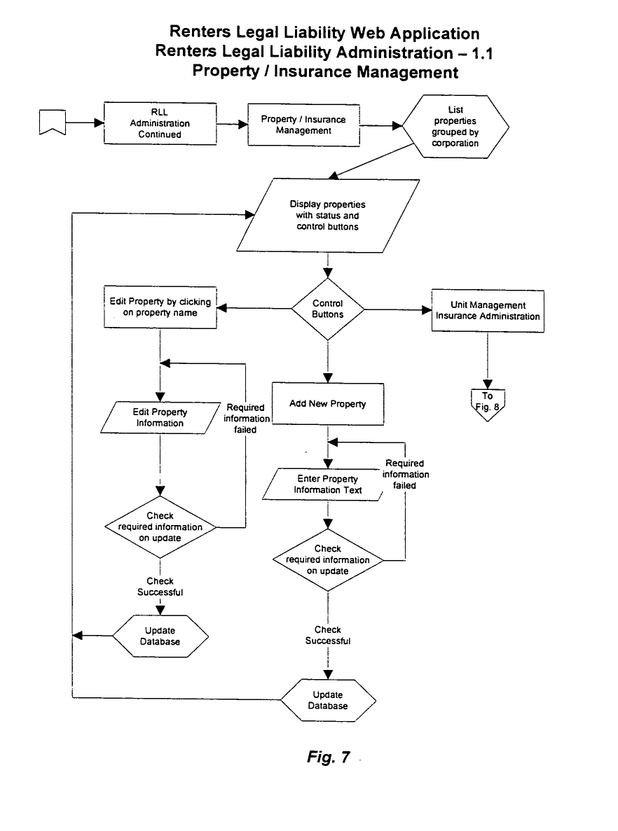

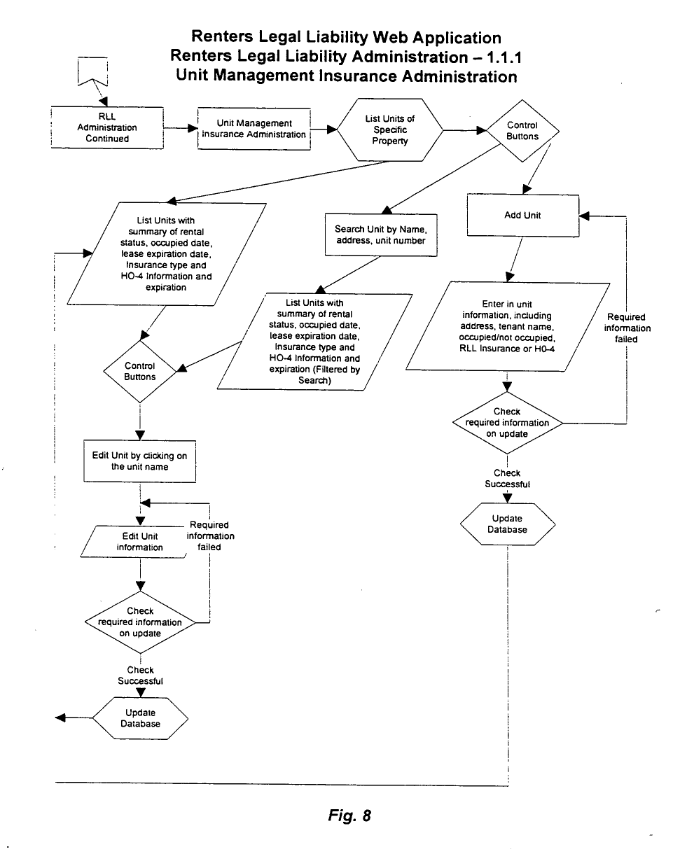

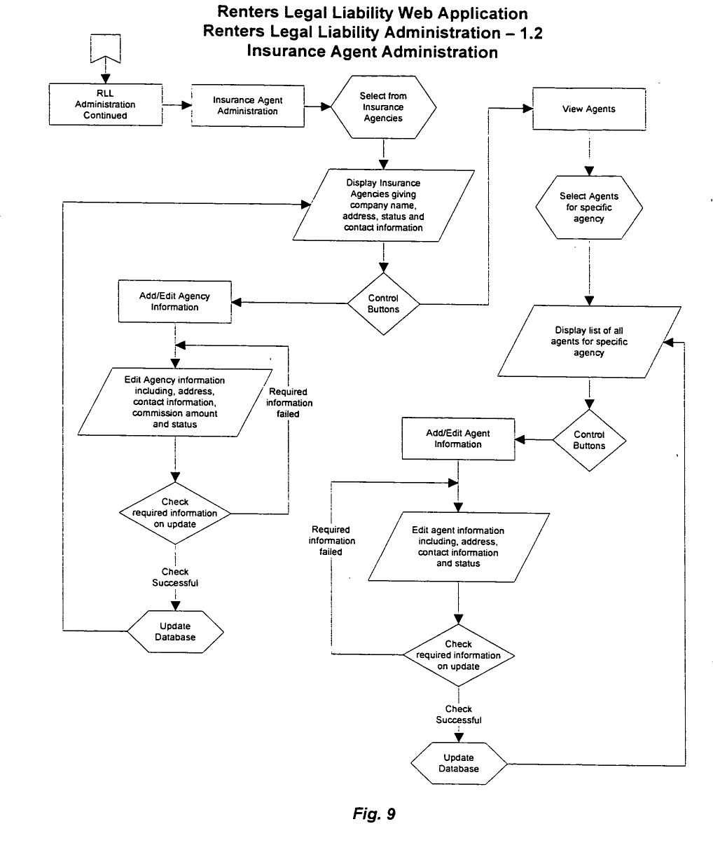

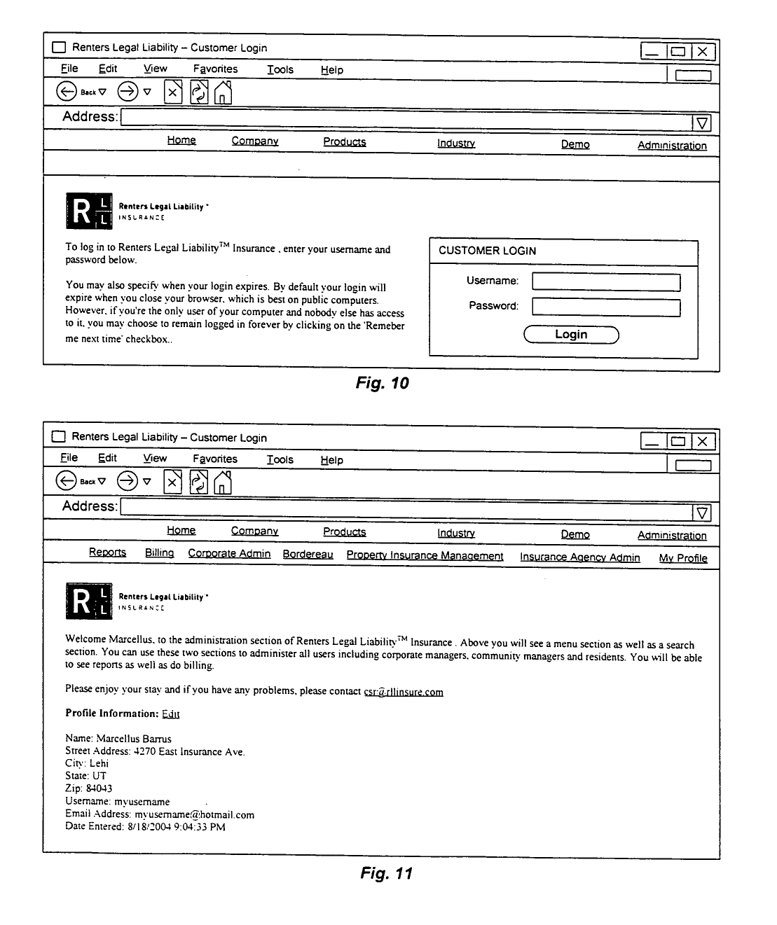

FIGS. 5 through 9 are a series of flow sheets illustrating an example of a preferred method for purchasing and issuing RLL and TOI insurance employing a copyrighted software program entitled “Residents Legal Liability” produced by Monitoring Computerized Services of Salt Lake City, Utah for use with a global information network 12. To enter the Renters Legal Liability website, the internet user will log in and be forwarded to a main page information with the ability to click on links such as Frequently Asked Questions page, the Contact Us page, and the How It Works page. Also on the main page will be a universal login to allow secure access to administration pages. The web site will be laid out in a very simple format to allow easy navigation and maintenance and fast download times with the ability to customize the look and feel. See FIG. 10, for an example.

Once a user enters the main website and logs in through the universal login, the user is connected to his/her administration depending on the permissions preset for the user. If a user is an administrator, he will be forwarded to the administrator section. If the user is a corporate manager, he will be forwarded over to the corporate manager section, etc.

Super Administration

The Super Administration area is where the administrators of RLL will go to administer all users within the RLL network. Different menus or portlets are available depending on a user's permissions. See FIG. 11 for an example of the administration sub-menu.

The administration menu gives the administrator access to the needed screens. An administrator can view reports, billing information, business information of property owners and their properties, insurance management of the individual properties, user administration, insurance agencies and the current user's profile. Through this menu system an individual administrator can update, view and maintain all aspects of the RLL Web Site.

Within the reports section the RLL administrator can view specific reports concerning RLL clients such as upcoming HO-4 expirations, upcoming lease expirations and current agent commissions. Additional reports such as how many users are active can also be available.

Within the billing section, the administrator can view the month-to-date summary of the amount to be billed within the specified month of all the units that are currently insured through the RLL system. The month-to-date summary is broken down by categories: the Property Owner, the different property names, and the number of units with each property. Past billing reports can also be pulled up within this area to allow the administrator to report of all billing activities that have previously occurred. The process of doing the billing does not happen through the RLL web site. The web site is used only to gather billing information. Once a month, the current billing information is gathered and sent to the RLL billing department. The billing process can be accomplished automatically through the functionality of the operating system.

At the beginning of every month, a billing invoice is sent to each property owner and property manager notifying him/her of their current billing status to allow him/her the ability to fix any discrepancies with their insured units within the Renters Legal Liability system. When an individual is entered in the first time, the monthly bill can be prorated and will be billed the following month. So, the first time an individual will be billed will take place the second month of activity with a partial bill for the partial month of activity plus the current month's bill. There are three applications that run on the server machine that run as scheduled programs once a month. The first has been code named ‘Billing Invoice’. This application runs through the billing history and notifies the property manager or owner of the current monthly bill. If there are any problems with this invoice, the property manager or owner has the ability to make the changes that are needed before the billing actually takes place.

The second application has been code named ‘Billing History’. This application runs the billing history. The data received from this application is live data for billing reports as well as what information is sent to the billing department.

The third application has been code named ‘Billing Batch’. The ‘Billing Batch’ application pulls all the appropriate billing information for that month from the database that the ‘Billing History’ application stored. Once this information is gathered, it is sent over the billing department to be billed.

Corporate administration gives the RLL administrator the go ahead to search for the different property owners and update their individual information. Information such as their contact data, phone numbers, addresses, billing information and information on their different properties can be changed or updated. Search functionality is built into the corporate administration are for quick lookup of hard to find information. Property owner information can also be added in this area.

A bordereau report is also accessible through the administration area. A bordereau report is a report that displays all currently insured units and their occupants. This report is transmitted electronically monthly through the global information network to the covering insurance underwriter.

Within the Property/Insurance Management area, the administration user can go into all properties to manage information such as property address location, contact numbers, property manager and tenant information. Additional administration features can be accomplished through this area as well, such as adding rental units to specific properties, adding and searching for specific tenants, adding and modifying tenant insurance information that deals specifically with the RLL insurance policy, an HO-4 insurance policy or a TOI. This administration area is also available to property owners and property managers.

The user administration section gives the administrator abilities to search, edit and add users. The administrator has the ability search by user type or last name, email address, company name, or username. One can search for users alphabetically as well. Once the user is found within the system, the administrator has the ability to edit or modify the user. When editing the user, the administration can change information such as name and company, address, contact information, permissions and properties managed if they are a property manager. Once changes are made the RLL system is updated immediately.

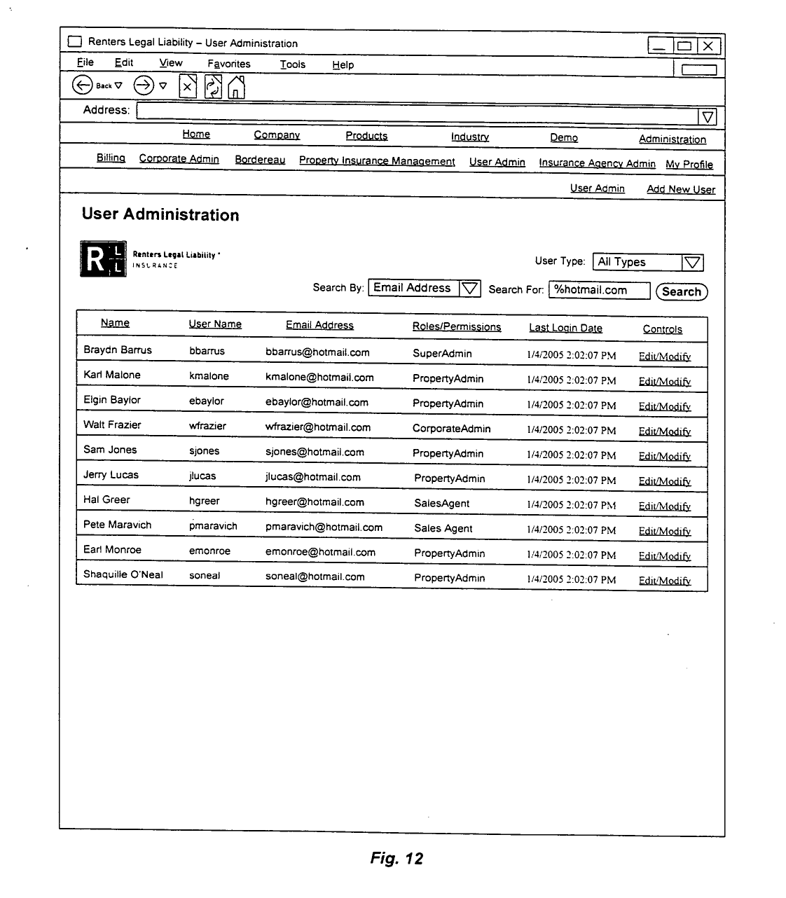

At the top of every screen within the user administration, as shown in FIG. 12, the user has the option of adding new users no matter what their type through the user administration sub menu. If a user is a corporate or community manager, the administrator will be able to drill down to their level and administer information specific to their communities. Notice that the administration menu and the user sub-menu remain intact to allow for easy navigation through the super administration section.

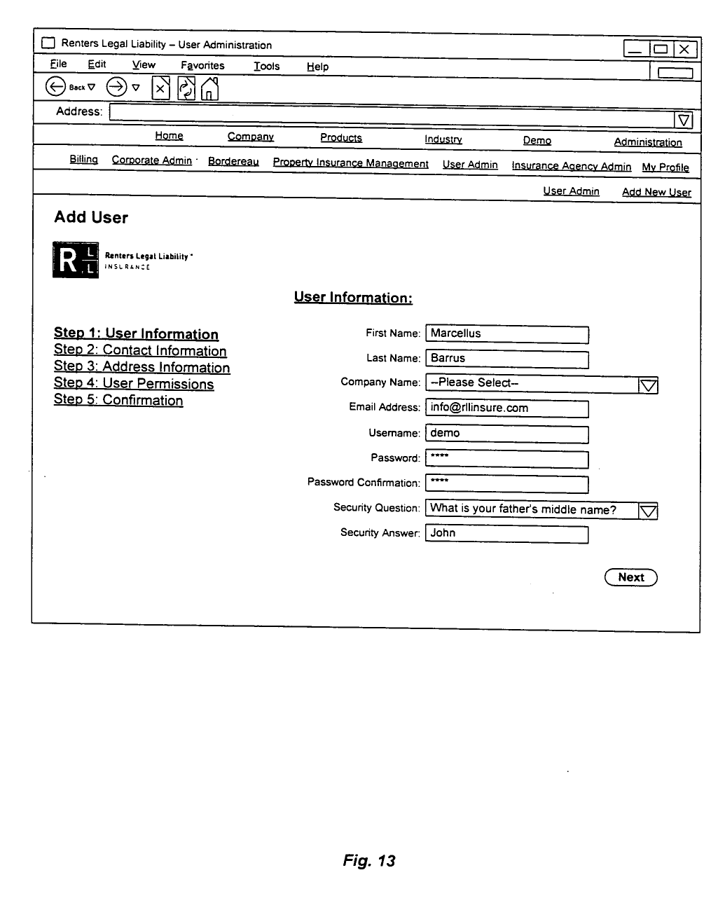

Adding a user is very straight forward, the required information is: the user type, first name, last name, username, password, email address, company name, business phone number, business fax and shipping and mailing addresses as seen in FIG. 13. Once this information is entered and the submit button is pressed, the user is added to the database. If the user permissions have been set on initial signup, the user immediately has access to this site and can immediately start administrating communities or residents.

Corporate and Community Administration

The ‘Corporate Administration’ and the ‘Property Administration’ areas are very similar to the ‘Super Administration’ area except that the corporate administrator only has access to his specific information. Depending on the permissions that have been set by the super administrator, the corporate administrator can add communities, search users, view billing information (not do billing), and view and modify residents if required. Searching capabilities will also be given to the corporate administrator but will be limited only to users that have been granted access by the super administrator.

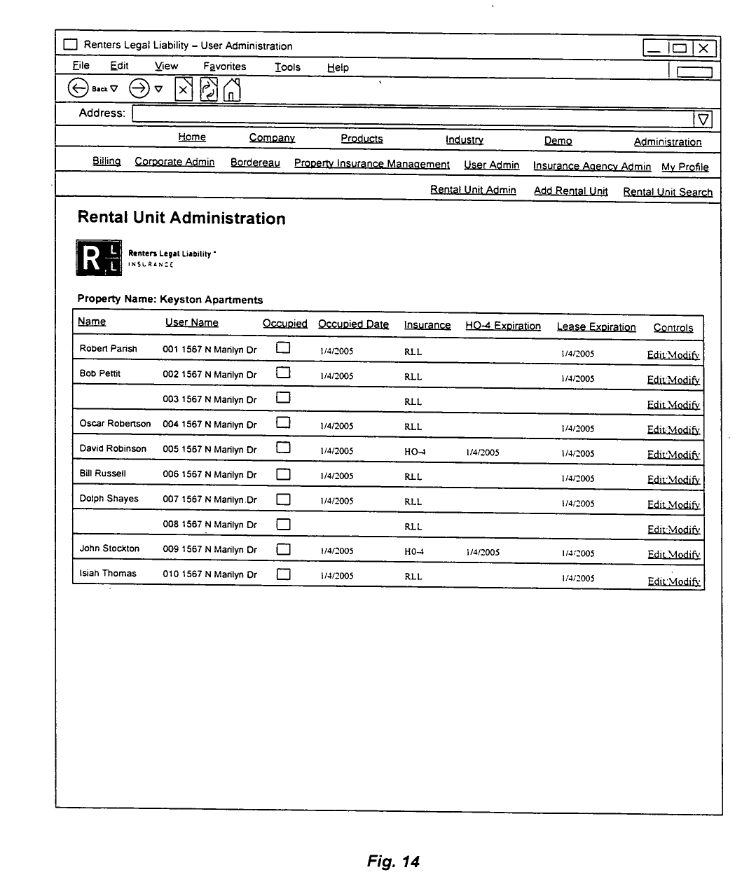

The property manager has the ability to add buildings to his community and residents to those buildings. FIG. 14 comes from the corporate administration section and depicts the capability to accomplish all required functions within the community. The property manager has the ability to go in and update rental information and assign residents to those units. With that registration, the property manager has the ability to add each resident to the Renter Legal Liability insurance policy. Thus, allowing each resident to have insurance.

Resident Registration

Resident information is managed through the Property/Insurance management area. Information such as when the lease expires, if the resident has an HO-4 or RLL insurance. If the resident has an HO-4, the HO-4 expiration will be available to add or update. This information will be used for reporting and billing information and will be accessible only to the super administrator, the corporate administrator and the community manager. Once a resident has been registered with the RLL system, a printed certificate can given to the resident stating that insurance has been obtained through the RLL administrator. This certificate can be programmed with the extensible markup language or XML and will be printer friendly to be printed at the time of lease signing. The super administrator, corporate administrator, community manager or the resident himself can pull up the certificate at any time. Also, at the conclusion of registration, the resident can confidently state that renter's legal liability insurance has been purchased.

Web Site Software

Renters Legal Liability is a fully functional web site monitored by Monitoring Computerized Services (MCS) of Salt Lake City, Utah to allow the RLL administrator the ability to easily administer rental insurance for owners and property managers. MCS has selected the Microsoft Windows Server 2003 with the Microsoft Internet Information Server (IIS) software to power the web site and the backend applications. IIS serves web pages for the RLL web site. IIS web server that is easily extendable to allow rapid customization to fit a specific profile of an individual company.

ASP.Net is the programming technology using the C# programming language. Because of the extendibility of IIS, ASP.Net can be compiled into it as a module to work as one. This allows a web site using the ASP.Net technology to run more smoothly and efficiently. Also, because the ASP.Net is being used as the programming technology, the RLL system isn't limited to using C# as its main programming language. Other languages compatible with the ASP.Net technology can be used, such as C++, C, Visual Basic.Net, Python and Perl.

Microsoft SQL Server is the backend database server. Microsoft SQL Server has the capability to process millions of records without degradation. It complies with most of the SQL92 and SQL99 specifications providing an easy migration to other databases if required.

Web Site Hardware

HP servers are examples of preferred web site hardware. To accommodate growth and web site reliability, the web site hardware may be partitioned into phases as business expands. Initially, MCS has only documented phase one hardware and will define phase two and three as appropriate. The present preferred hardware comprises:

HP LP 2000r

4—120 Gig Hardrive
1—Raid Scsii Controller (NetRaid 4)
2—10/100/1000 BaseT NIC
2—Gig Memory
1—Video Card
1—DVD-ROM
1—DDS3
2—3.2 mhz Processors
2—Power Supplies
Rack Mounted
Windows 20003 Server OS
   Web Site Hosting

Web hosting is facilitated by VIA West in Salt Lake City. VIA West specializes in delivering quality broadband access, shared and dedicated server-hosting, collocation and managed services consulting to small and medium-sized businesses.

The configuration of the method and apparatus is adjusted to provide the informational data and reports required to enforce and administer building insurance lease requirements. In addition, the apparatus may employ a heuristic program to insure the high degree of accuracy and statistically reliability of the uninsured-tenant lists.

Although the foregoing specification refers to the illustrated embodiments, it is not intended to restrict the scope of the appended claims. The claims themselves recite those features deemed essential to the invention.

I claim:

1. A method for insuring an apartment or multi-unit dwelling unit comprising:
a. inputting into a computer processor a database of building physical information, the number of units in the apartment complex or multi-unit dwelling complex to qualify the complex for fire insurance coverage, actuarial insurance rates for renter's legal liability insurance, and other relevant information,
b. qualifying the apartment or multi-unit dwelling via an algorithm processing the building physical information and number of units, and the tenant data for renters legal liability insurance covering the building owner from unintentional damage caused by the tenant from one or more of the perils selected from the group comprising fire; smoke; explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, pursuant to predetermined insurability criteria,
c. issuing tenant insurance covering the building owner and/or property manager of the complex from the selected perils at a rate based on the number of insured units, and
d. billing the owner for the renter's legal liability insurance coverage.

2. A method for insuring an apartment or multi-unit dwelling unit according to claim 1, wherein the building physical information comprises the full name of the insured, the mailing addresses of the building units, the number of buildings and units, the fire insurance policy on the building and rating by the four basic types of construction recognized in fire insurance coverage and including building owner coverage for negligence injuries by the tenant caused to third parties.

3. A method for insuring an apartment or multi-unit dwelling unit according to claim 1, including adding commission and management fees to the actuarial insurance rates for inclusion in the billings of the owner.

4. A method for insuring an apartment or multi-unit dwelling unit according to claim 3, wherein the relevant information includes tenant rental information, which may include lease agreement requirements, the limits of coverage, a credit report on the tenant coded to meet legal confidentiality requirements, a criminal background check of the tenant, and a character reference check of the tenant to verify his past tenant conduct.

5. A method for insuring an apartment or multi-unit dwelling unit according to claim 1, wherein the building physical information, relevant information, and tenant rental information is inputted monthly.

6. A method for insuring an apartment or multi-unit dwelling unit according to claim 1, wherein the renters legal liability insurance covers both the owner and the tenant and the tenant's personal property within the unit.

7. A method for insuring an apartment or multi-unit dwelling unit according to claim 6, including providing on-line real time computer display access to tenants to purchase either renters legal liability or tenant occupancy insurance.

8. A method for insuring an apartment or multi-unit dwelling unit according to claim 1, including mailing notices requesting insurance verification to uninsured tenants and inputting and updating the working database with the uninsured tenants' replies to the notices.

9. A method for insuring an apartment or multi-unit dwelling unit according to claim 1, including computer generating and transmitting trend report summaries of the status of uninsured tenants to authorized parties.

10. A method for insuring an apartment or multi-unit dwelling unit according to claim 9 wherein the trend report summaries are telecommunicated and coded and masked for confidential access.

11. A method for insuring an apartment or multi-unit dwelling unit according to claim 10, including providing computer on-line access to a tenant to the insurance database via interactive computer screens enabling the tenant to select the tenant occupancy insurance limits of coverage, and computer generating a bill for the tenant occupancy insurance based on the number of units in the building and the limits of coverage, which is provided along with a tenant's monthly rental statement.

12. A method for insuring an apartment or multi-unit dwelling unit comprising:
a. inputting into a computer processor a database of building physical information about the apartment complex or multi-unit dwelling complex which may include the full name of the insured, the mailing addresses of the building units, the number of buildings and units, the fire insurance policy on the building and rating by the four basic types of construction recognized in fire insurance coverage, and actuarial insurance rates for renter's legal liability insurance, and other relevant information,
b. inputting into a computer relevant tenant rental information, which may include lease agreement requirements, the limits of coverage, a credit report on the tenant coded to meet legal confidentiality requirements, a criminal background check of the tenant, and a character reference check of the tenant to verify his past tenant conduct,
c. computer qualifying the apartment or multi-unit dwelling via an algorithm processing the building physical information and the tenant data for renters legal liability insurance covering the building owner from unintentional damage caused by the tenant from one or more of the perils selected from the group comprising fire; explosion, including the explosion of gases or fuel within the furnace of any fired vessel or within the flues or passages through which the gases of combustion pass, not including loss or damage by rupture, bursting or operation of pressure relief devices; or rupture or bursting due to expansion or swelling of the contents of any building structure, caused by or resulting from water; smoke causing sudden and accidental loss or damage not including smoke from agricultural smudging or industrial operations; and water that backs up or overflows from a sewer, drain or sump, and water or other liquids that leak, flow or overflows from plumbing heating air conditioning, or other equipment fixtures pursuant to predetermined insurability criteria, and
d. computer generating a base rate charge for the renters legal liability insurance based on the building physical information and number of units in the complex, and the limits of coverage, issuing renters legal liability insurance covering the building owner of the complex, and billing the owner for the renters legal liability insurance coverage.

13. A method for insuring an apartment or multi-unit dwelling according to claim 12, including generating tenant occupancy insurance which provides a pre-set amount of coverage for displaced tenants, and an additional sum for living expenses to the tenant unintentionally causing damage to the dwelling unit.

14. A method for insuring an apartment or multi-unit dwelling according to claim 12, wherein the renter's legal liability insurance covers the building owner's property for replacement cost.

15. A method for insuring an apartment or multi-unit dwelling according to claim 13, wherein the tenant occupancy insurance includes disability insurance, which pays the lease payment in the event an insured tenant is disabled.

16. A method for insuring an apartment or multi-unit dwelling according to claim 15, wherein the tenant occupancy insurance includes disability insurance, which also provides income benefits to the disabled tenant.

17. A method for insuring an apartment or multi-unit dwelling according to claim 13, wherein the tenant occupancy insurance includes an accidental death benefit payable to a beneficiary in the event of death of the tenant.

18. A method for insuring an apartment or multi-unit dwelling according to claim 12, wherein the owner is billed for renters legal liability and/or tenant occupancy insurance to be paid by the tenant on lease renewal or generation.

19. A method for insuring an apartment or multi-unit dwelling according to claim 13, including requiring tenants who have opted to independently purchase tenant occupancy insurance to issue an insurance certificate naming the property owner as an additional insured and/or certificate holder of record, and inputting property owner's notice of tenants' insurance cancellation into the computer and monitoring the unit insurance coverage via computer.

20. A method for insuring an apartment or multi-unit dwelling according to claim 19, wherein the tenants' insurance cancellation is monitored from a remote monitor interconnected to the computer.

21. A method for insuring an apartment or multi-unit dwelling according to claim 19, wherein tenants allowing their insurance to lapse are automatically insured for renter's legal liability insurance and computer billed therefore.

22. A method for insuring an apartment or multi-unit dwelling according to claim 12 wherein the provider of the renters legal insurance provides credits against policies covering the property owner who has 100% of the tenants' units insured.

23. A method for insuring an apartment or multi-unit dwelling according to claim 22, wherein renter's legal liability certificates are issued to those insurance companies offering credits against policies.

24. A method for insuring an apartment or multi-unit dwelling according to claim 23, including computer linking the web site of those companies receiving renters legal liability certificates with the computer.

25. A method for insuring an apartment or multi-unit dwelling according to claim 13, wherein the tenant occupancy insurance includes traditional HO-4 form policy coverage for the tenant.

26. A method for insuring an apartment or multi-unit dwelling according to claim 25, including computer linking the web site of those companies providing HO-4 form policy coverage with the computer.

27. A method for insuring an apartment or multi-unit dwelling according to claim 26, including allowing insurance companies offering traditional HO-4 form policies to advertise on the computer network.

28. A method for insuring an apartment or multi-unit dwelling according to claim 26, wherein the computer billing includes the fee for providing tradition HO-4 form policies.

29. A method for insuring an apartment or multi-unit dwelling according to claim 28, wherein the computer billing also includes a fee for management.

30. A renter's legal liability insurance policy in a permanent written or unalterable media embodiment listing the coverage provided covering the unit according to the method of claim 1.

31. A renter's legal liability insurance policy according to claim 30, wherein the renter's legal liability insurance policy includes additional tenant occupancy insurance coverage, which also covers the tenant and the tenant's personal property in addition to damage to the unit.

32. A renter's legal liability insurance policy according to claim 31, wherein the tenant occupancy insurance coverage policy allows the tenant to acquire coverage by paying an additional insurance premium as part of the unit rent.

33. An apparatus for insuring an apartment or multi-unit dwelling unit comprising:
a. input means,
b. computer storage means
c. a data base inputted into the computer storage means of
i. sufficient building physical information about the apartment complex or multi-unit dwelling complex and number of units to qualify the complex for fire insurance coverage,
ii. sufficient tenant data to qualify the complex for renter's legal liability insurance coverage,
iii. actuarial insurance rates for renter's legal liability insurance, and other relevant information,
d. a computer processor associated with the input and computer storage means database to:
i. qualify the apartment or multi-unit dwelling unit for renters legal liability insurance to protect the landowner from unintentional damage caused by the tenant from one or more the perils selected from the group comprising fire; smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures and to calculate the insurance rates based on tenant occupancy,
ii. generate a base rate charge for the renters legal liability insurance based on the building physical information and number of units in the complex, and
iii. issue renters legal liability insurance in a permanent unalterable media embodiment listing the coverage provided covering the complex, and billing the owner for the renters legal liability insurance coverage; and
e. an interactive display terminal operably associated with and activated by the computer processor to display insurance rates and allow interested parties to purchase renters legal liability insurance.

34. An apparatus for insuring an apartment or multi-unit dwelling unit according to claim 33, wherein the database includes:
i. building physical information about the apartment complex or multi-unit dwelling complex which may include the full name of the insured, the mailing addresses of the building units, the number of buildings and units, the fire insurance policy on the building and rating by the four basic types of construction recognized in fire insurance coverage,
ii. tenant rental information, which may include lease agreement requirements, a credit report on the tenant coded to meet legal confidentiality requirements, a criminal background check of the tenant, and a character reference check of the tenant to verify his past tenant conduct.

35. An apparatus for insuring an apartment or multi-unit dwelling unit according to claim 34, including electronic signal transfer means to transmit coded electronic signals to a receiving translator, which converts the coded electronic signals into printed reports for authorized building owners, managers, or insurance carriers.

36. A method for insuring an apartment or multi-unit dwelling unit according to claim 1, wherein the renters legal liability insurance to protect the landowner from unintentional damage caused by the tenant from two or more the perils selected from the group comprising fire, smoke, explosion, including the explosion of gases or fuel within the furnace of any fired vessel or within the flues or passages through which the gases of combustion pass; and water that backs up or overflows from a sewer, drain or sump, and water or other liquids that leak, flow or overflows from plumbing heating air conditioning, or other equipment fixtures, and negligence injuries by the tenant caused to third parties pursuant to predetermined insurability criteria.

37. A method for insuring an apartment or multi-unit dwelling unit according to claim 36, wherein the renters liability insurance protects the owner from unintentional damage caused by the tenant from three or more perils.

38. A method for insuring an apartment or multi-unit dwelling unit according to claim 37, wherein the renters liability insurance protects the owner from unintentional damage caused by the tenant from four or more perils.

39. A renter's legal liability insurance policy in a permanent written or unalterable media embodiment listing the coverage provided covering the unit according to the method of claim 36.

40. A renter's legal liability insurance policy in a permanent written or unalterable media embodiment listing the coverage provided covering the unit according to the method of claim 37.

41. A renter's legal liability insurance policy in a permanent written or unalterable media embodiment listing the coverage provided covering the unit according to the method of claim 38.

42. A renter's legal liability insurance policy according to claim 36, wherein the renter's legal liability insurance policy includes additional tenant occupancy insurance coverage, which also covers the tenant and the tenant's personal property in addition to damage to the unit.

43. A renter's legal liability insurance policy according to claim 42, wherein the tenant occupancy insurance coverage policy allows the tenant to acquire coverage by paying an additional insurance premium as part of the unit rent.

44. A renter's legal liability insurance policy according to claim 36, wherein the renter's legal liability insurance policy includes additional tenant occupancy insurance coverage, which also covers the tenant and the tenant's personal property in addition to damage to the unit.

45. A renter's legal liability insurance policy according to claim 36, wherein the tenant occupancy insurance coverage policy allows the tenant to acquire coverage by paying an additional insurance premium as part of the unit rent.

46. A renter's legal liability insurance policy according to claim 37, wherein the renter's legal liability insurance policy includes additional tenant occupancy insurance coverage, which also covers the tenant and the tenant's personal property in addition to damage to the unit.

47. A renter's legal liability insurance policy according to claim 38, wherein the tenant occupancy insurance coverage policy allows the tenant to acquire coverage by paying an additional insurance premium as part of the unit rent.
